(19) United States
(12) Patent Application Publication
(10) Pub. No.: US 2025/0187457 A1
(43) Pub. Date: Jun. 12, 2025

(54) BASE ASSEMBLY FOR AN INDUCTIVE CHARGING DEVICE

(71) Applicant: MAHLE International GmbH, Stuttgart (DE)

(72) Inventors: Mike Boettigheimer, Kornwestheim (DE); Thomas Himmer, Reichenbach (DE); Christopher Laemmle, Stuttgart (DE); Holger Schroth, Maulbronn (DE); Martin Steinbach, Waiblingen (DE)

(21) Appl. No.: 18/844,942

(22) PCT Filed: Feb. 28, 2023
(86) PCT No.: PCT/EP2023/054956

§ 371 Date: Sep. 6, 2024

(30) Foreign Application Priority Data
Mar. 9, 2022 (DE) 10 2022 202 345.5

(51) Int. Cl. B60L 53/12; B60L 53/302

(52) U.S. Cl. CPC B60L 53/12; B60L 53/302

(57) ABSTRACT

A floor assembly for an inductive charging device is disclosed. The floor assembly includes a base plate and a coil spaced apart from each other in a spacing direction. A core arrangement having at least one core body for magnetic flux guidance is arranged between the base plate and the coil. A cavity is formed between the core arrangement and the base plate. At least one support column extends between at least one of the at least one core body and the base plate. An electronic system arranged in the cavity. The support column has a contour. The electronic system is mechanically pressurized against the base plate in the spacing direction via the contour.

### CROSS-REFERENCE TO RELATED APPLICATIONS

This application claims priority to International Patent Application No. PCT/EP2023/054956 filed Feb. 28, 2023, which also claims priority to German Patent Application No. DE 10 2022 202 345.5 filed Mar. 9, 2022, the contents of each of which is hereby incorporated by reference in its entirety.

### TECHNICAL FIELD

The present invention relates to a floor assembly for an inductive charging device for inductive charging of a motor vehicle.

### BACKGROUND

Motor vehicles usually have an electrical energy storage device, for example a rechargeable battery, for the electrical supply of electrical consumers. Particularly in the case of motor vehicles that are at least partially electric, the electrical energy storage device, which is also generally referred to below as a battery, is also used to drive the motor vehicle and is therefore in particular a traction battery.

In order to recharge such energy storage devices, it is conceivable to connect energy storage devices directly electrically to an electrical energy source, for example a charging point, a mains connection and the like. This usually requires a manual action by a user, in particular to establish said electrical connection.

It is also known to charge the vehicle, i.e., the battery in particular, inductively. Corresponding charging devices each have an assembly in the vehicle and outside the vehicle. The stationary assembly outside the vehicle contains a primary coil which interacts inductively with a secondary coil of the assembly in the vehicle in order to charge the vehicle. The assembly in the vehicle is also referred to as a vehicle assembly. The assembly outside the vehicle is usually located underneath the vehicle during operation and is also referred to as the floor assembly.

Heat is generated during operation of the floor assembly. This heat can damage the floor assembly and/or reduce the performance of the floor assembly.

The present invention deals with the task of providing an improved or at least different embodiment for a floor assembly of the aforementioned type, which in particular eliminates disadvantages from the prior art. In particular, the present invention deals with the task of providing an improved or at least different embodiment for the floor assembly, which is characterized by increased performance and/or improved resistance and/or simplified manufacture.

According to the invention, this task is solved by the object of independent claim(s). Advantageous embodiments are the subject of the dependent claims.

### SUMMARY

Therefore, the present invention is based on the general idea of mechanically biasing an electronic system of the floor assembly towards a base plate of the floor assembly by means of contours of support columns. This results in a defined and simple positioning of the electronics relative to the base plate using existing means, so that the heat transfer between the electronic system and the base plate is increased with simplified production. The improved heat transfer between the electronic system and the base plate means that the electronic system is cooled in a simplified manner during operation. This allows the floor assembly to be operated with increased power. In particular, intended power reductions to avoid thermal damage, also known as “derating”, are avoided or at least reduced in this way. As a result, the floor assembly can be operated with increased power, even at increased ambient temperatures. In addition, damage to the floor assembly, in particular to the electronic system, caused by increased temperatures is avoided or at least reduced in this way. As a result, the service life of the floor assembly is increased and its durability is thus improved.

In line with the idea of the invention, the floor assembly has the base plate and a coil, which are spaced apart from one another in a direction also referred to below as the spacing direction. The floor assembly also has a core arrangement comprising at least one core body for guiding the magnetic flux. The core arrangement is spaced from the base plate and the coil in the spacing direction. Furthermore, the core arrangement is arranged between the base plate and the coil. A cavity is formed between the core arrangement and the base plate. At least one body extends between at least one of the at least one core body and the base plate, which extends through the cavity in the spacing direction and supports the core arrangement on the base plate. The body is also referred to below as a support column. At least one of the support columns has a contour. An electronic system of the floor assembly is also arranged in the cavity. The electronic system is mechanically pressurized against the base plate in the spacing direction by means of at least one of the at least one contours.

In the present case, “contour” of the support column means a cross-section of the support column that changes in the spacing direction. This means that the extension of the support column varies transversely to the spacing direction along the spacing direction, so that at least one such contour is present.

At least one contour can extend around the spacing direction, in particular in a closed circumferential manner, over the associated support column. In particular, the contour can be symmetrical with regard to rotations around the spacing direction.

It is also conceivable that at least one contour is only arranged locally around the spacing direction. Accordingly, the contour is asymmetrical with regard to rotations around the spacing direction.

The respective support column can have any basic shape. In particular, the respective support column can have a basic shape that is at least doubly symmetrical with respect to rotations about the spacing direction. In particular, it is conceivable that at least one support column has a cylindrical basic shape.

The floor assembly is used in a charging device for inductive charging of an electrical energy storage device, hereinafter also referred to as a battery, of a motor vehicle. The floor assembly is stationary and interacts with an assembly of the motor vehicle for this purpose. In the charging device, the coil of the floor assembly acts as a primary coil with a secondary coil of the assembly on/in the motor vehicle. During operation, the primary coil generates an alternating magnetic field which interacts inductively with the secondary coil.

For this purpose, the floor assembly is usually located on a surface or is embedded in a recess in the underground. The spacing direction runs along the soldering direction so that the base plate of the floor assembly is arranged at the bottom along the soldering direction.

The floor assembly is designed to transfer mechanical pressures acting on it during operation to the base plate and from the base plate to the underground or in a recess made in the underground without causing damage. This means that the floor assembly is designed such that a motor vehicle can be parked on the floor assembly and/or drive over the floor assembly without causing damage to the floor assembly. In particular, the at least one support column serves to transfer loads to the base plate such that the core arrangement remains undamaged.

The respective support column only extends locally in the cavity transverse to the spacing direction. This means in particular that the at least one support column penetrates the cavity but does not fill it.

Preferably, at least one of the at least one core bodies, particularly preferably the respective core body, rests locally on one of the at least one support columns with its underside facing the base plate. This means that the contact surface with which the underside rests on the support body is smaller than the entire underside. There is therefore a local load transfer from the core body to the support column. This leads to a reduced risk of damage to the core body, in particular the risk of breakage, due to the reduced bending stress that is thus achieved.

In principle, the floor assembly can only have one such support column. Preferably, the floor assembly has at least two support columns spaced apart from each other transversely to the spacing direction.

The respective support column is advantageously fixed to the base plate at least in the state of the floor assembly arranged on the underground and/or in the underground. This leads to a defined and predetermined distance between the support column and the base plate and consequently to a correspondingly defined and predetermined distance between the contour and the base plate. This results in a defined and/or predetermined mechanical pressure on the electronic system in the direction of the base plate.

The respective support column can be fixed to the base plate in any way. This is done, for example, by means of a material connection, such as an adhesive bond, between the support column and the base plate. Alternatively or additionally, the respective support column can be fixed to the base plate by means of a screw connection.

The electronic system is advantageously used to operate the floor assembly. In particular, the electronic system can be used to supply the coil of the floor assembly. The electronic system can therefore be a power electronic system in particular.

The electronic system advantageously has a printed circuit board, also known to the person skilled in the art by the abbreviation “PCB”, and/or at least one electronic component, in particular at least one electronic power component. Advantageously, at least one of the electronic components is arranged on the side of the electronic system facing the base plate. Since such components usually generate increased heat during operation, this results in improved cooling of the electronic system via the base plate.

Preferably, the electronic system has a printed circuit board to which at least one such electronic component is attached. Particularly preferred are embodiments in which at least one of the components is arranged on the side of the printed circuit board facing the base plate.

In addition to supporting the support columns and thus transferring the load to the underground and/or in the recess in the underground, the base plate is also used for temperature control, in particular cooling, of the floor assembly, especially the electronic system. The base plate is therefore also a cooling plate.

Preferably, the base plate is also designed to shield magnetic and/or electromagnetic radiation. For this purpose, the base plate is made of a metal or a metal alloy, for example.

For improved temperature control of the floor assembly, the base plate can have at least one channel through which a fluid can flow during operation and, in particular, absorb heat.

In advantageous embodiments, a thermal interface material, also known by the abbreviation “TIM”, is arranged between the electronic system and the base plate. This improves the heat transfer between the electronic system and the base plate and thus, in particular, the cooling of the electronic system.

It is preferable for the thermal interface material to be in direct contact with the electronic system and/or the base plate. This leads to a further increase in heat transfer between the electronic system and the base plate.

In preferred embodiments, the thermal interface material is pressed against the base plate by the pressure acting on the electronic system by means of the contour. This means that the electronic system exerts a mechanical pressure against the base plate by means of the contour and thus presses the thermal interface material against the base plate. This results in improved and/or more extensive thermal contact between the base plate and the thermal interface material as well as between the thermal interface material and the electronic system. As a result, the heat transfer between the electronic system and the base plate is improved.

Embodiments in which the thermal interface material is elastic in the spacing direction are preferred, wherein the impact compresses the thermal interface material in the spacing direction. The compression of the thermal interface material reduces the thermal transfer resistance between the electronic system and the base plate. As a result, the heat transfer between the electronic system and the base plate is further improved. In addition, the elastic properties of the thermal interface material compensate for any changes in the spacing direction that may occur during operation and/or during the service life of the assembly. In other words, the elastic property of the thermal interface material and the application of the thermal interface material by means of the at least one contour against the base plate also ensure that these changes are compensated for even if changes in distance occur, which may be due to thermal and/or wear, and at the same time the thermal connection between the base plate and the electronic system is maintained. This increases and stabilizes the heat transfer over the service life and/or during operation of the floor assembly.

In principle, it is possible to arrange the thermal interface material completely and over the entire surface between the electronic system and the base plate. This means that the interface material is arranged entirely between the electronic system and the base plate.

It is also conceivable to arrange the thermal interface material only in areas with increased heat generation. These areas include, in particular, the electronic components of the electronic system. Accordingly, the thermal interface material can only be arranged locally between at least one electronic component and the base plate.

In principle, the thermal interface material can be any material.

In particular, the thermal interface material can be made from at least one polymer filled with thermally conductive particles. This filled polymer can be applied as a curable paste, for example by screen printing, dispensing and the like. The curing can take place either in the complete assembly, i.e., in a sandwich construct between the base plate and the electronic system. Likewise, the curing can be carried out only on one side, i.e., applied either to the base plate or to the electronic system.

In preferred embodiments, the thermal interface material is compressed against the base plate by applying a predetermined pressure to the electronic system in the direction of the base plate. Advantageously, this pressure is at least 0.1 bar, preferably at least 0.5 bar, particularly preferably at least 1 bar.

The electronic system can be impacted in the direction of the base plate by means of the at least one contour either directly by means of at least one contour or indirectly by means of at least one contour. Of course, it is also conceivable that at least one contour acts directly on the electronic system in the direction of the base plate and at least one contour acts indirectly on the electronic system or another electronic system against the base plate.

When a contour is applied directly, the electronic system, preferably the printed circuit board, is in direct mechanical contact with the contour.

It is preferable for at least one of the at least one contours to mechanically act on the electronic system, in particular the printed circuit board, directly in the spacing direction against the base plate. Advantageously, the contour lies on the side of the electronic system, in particular the printed circuit board, facing away from the base plate.

In the case of indirect application by means of the contour, another body is provided between the contour and the electronic system, which is also referred to below as a hold-down device. The contour acts mechanically on the hold-down device, which in turn acts mechanically on the electronic system in the direction of the base plate. Advantageously, the hold-down device is in direct mechanical contact with both the contour and the electronic system.

It is preferable if at least one hold-down device is arranged in the cavity. In this case, at least one of the at least one contours of at least one support column acts mechanically on at least one of the at least one hold-down device in the direction of the base plate, so that the at least one hold-down device acts mechanically on the electronic system in the spacing direction against the base plate.

In preferred embodiments, the hold-down device is made of a material that is as magnetically and/or electromagnetically inactive as possible, preferably a plastic. At least one hold-down device is therefore preferably a plastic body. This means that there is no or at least reduced interaction of the hold-down device with the magnetic and/or electromagnetic field present in the cavity during operation. This leads to a reduced impairment of the function of the floor assembly. The plastic is preferably one with a low creep tendency, in particular polyamides, “PA” for short, and/or polyethersulfone, “PES” for short.

Advantageous are embodiments in which at least one of the at least one hold-down device is designed as a spring element acting in the spacing direction. In this way, changes in spacing direction that occur during operation and are caused by thermal factors, for example, can be compensated for. This results in the electronic system and/or the thermal interface material being subjected to a predetermined and/or defined pressure in the direction of the base plate. In addition, the spring element allows the floor assembly to be manufactured in a simplified manner.

To form the hold-down device as a spring element, the hold-down device can be made of a flat material by forming the material.

At least one of the contours can be formed on the associated support column, i.e., monolithic with the associated support column.

Similarly, at least one of the contours can be inconceivable attached to the associated support column. This means that the contour and the support column can be manufactured separately and then attached to each other.

It is also conceivable that at least one of the at least one contours on the associated support column can be adjusted along the spacing direction. This means that the distance between the contour and the electronic system and thus the mechanical pressure, in particular the pressure, caused by the contour can be changed by adjusting the contour. Consequently, it is possible in particular to adjust the contour in the spacing direction as required, for example after a certain period of operation of the floor assembly, in order to adjust the pressure acting on the electronic system accordingly. This also makes it easier to adapt the pressure to the local conditions when setting up the floor assembly.

In principle, the contour on the associated support column can be adjusted in any spacing direction.

It is conceivable to attach the contour to the support column by means of a thread for this purpose.

In principle, the coil of the floor assembly can be of any design. Advantageously, the coil has at least one coil winding. It is also conceivable that the coil has two or more coil windings.

In preferred embodiments, the coil is designed as a flat coil. This results in a compact design of the floor assembly and/or a more extensive interaction with the secondary coil.

As explained above, the at least one core body of the core arrangement serves to guide the magnetic flux of the field generated by the coil. The at least one core body is designed accordingly. The core arrangement ensures that propagation of the magnetic field in the direction of the base plate is prevented or at least reduced. This leads in particular to a reduction in energy losses and consequently to an increase in efficiency. For this purpose, the at least one core body preferably has a relative magnetic permeability μᵣ of at least two. The following therefore applies to the relative magnetic permeability μᵣ of the at least one core body: μᵣ≥2. In addition, the at least one core body is electrically isolated from the coil for this purpose. In particular, the core body is a ferrite body. It is advantageous if the at least one core body extends transversely to the spacing direction in the form of a plate. The respective core body is therefore advantageously a ferrite plate.

Preferably, the core arrangement has at least two core bodies, wherein the floor assembly for the respective core body has an associated support column.

It is particularly preferred if the assembly for the respective core body has an associated support column of this type. In this case, the respective support column extends in the spacing direction between the associated core body and the base plate and supports the associated core body on the base plate. Particularly preferably, at least one of the at least one core body, advantageously the respective core body, rests exclusively on the associated support column with its underside facing the base plate. Load transmission in the spacing direction in the direction of the base plate thus takes place exclusively via the associated support column. This leads to a reduced bending stress on the at least one core body and thus to a particularly effective reduction in the risk of damage and/or breakage of the at least one core body.

It is conceivable that the electronic system extends over the entire base plate. This means that the electronic system can cover the entire base plate.

It is conceivable that the electronic system has at least two electronic modules, each of which can have a printed circuit board and at least one electrical component. At least one of the electronic modules, preferably the respective electronic module, is pressurized in the direction of the base plate by means of at least one such contour.

Advantageously, the electronic system or the electronic modules only partially cover the base plate so that the base plate remains partially free. In this way, the base plate also tempers, in particular cools, the temperature of the cavity and/or the core arrangement and/or the coil.

Further important features and advantages of the invention are apparent from the sub-claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

These show, schematically in each case, in

FIG. 1 a highly simplified illustration of an inductive charging device with a floor assembly and a motor vehicle,

FIG. 2 the view from FIG. 1 for another exemplary embodiment

FIG. 3 a section through the floor assembly in the region of a support column,

FIG. 4 a section through the floor assembly in another embodiment,

FIGS. 5 to 8 side views of the support column for a different exemplary embodiments in each case.

### DETAILED DESCRIPTION

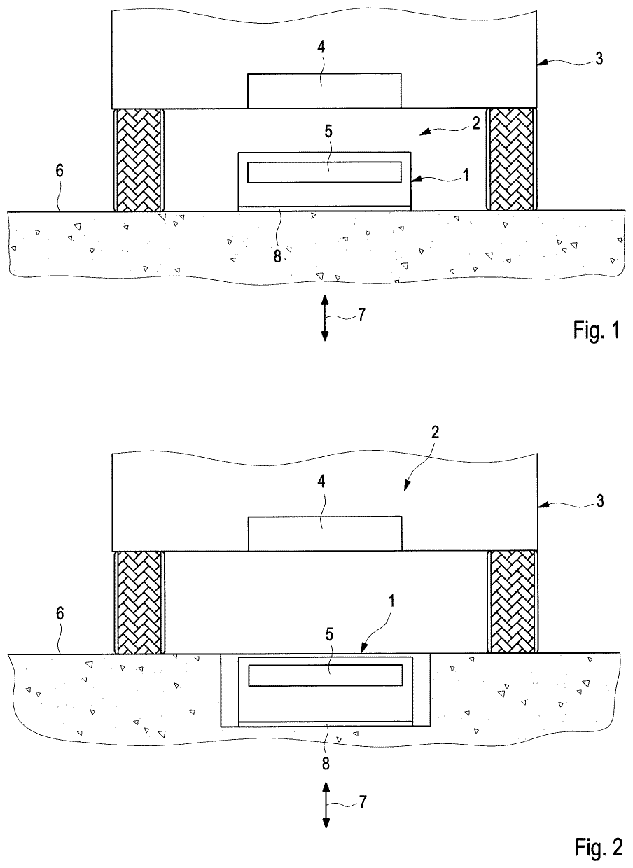

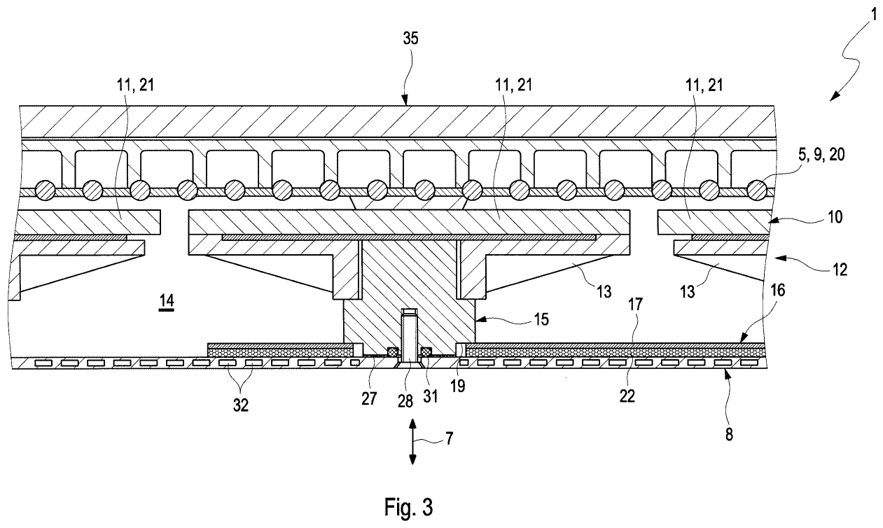

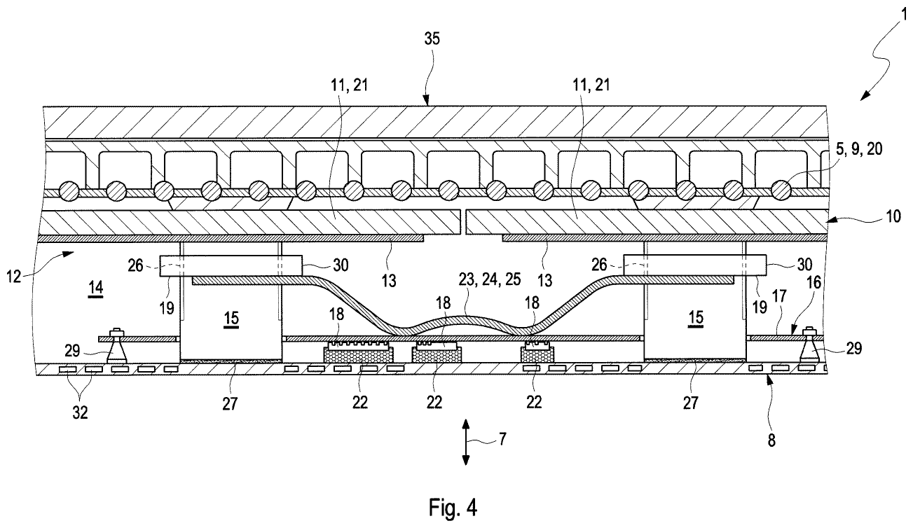

A floor assembly 1, as shown for example in FIGS. 1 to 4, is used in a charging device 2, shown in FIGS. 1 and 2 as an example and in a highly simplified form, for inductive charging of an electrical energy storage device of a motor vehicle 3, which is not shown. For inductive charging of the electrical energy storage device, the floor assembly 1 interacts with an associated assembly 4 of the motor vehicle 3. The interaction takes place through a coil 5 of the floor assembly 1, which serves as the primary coil 5 of the charging device 2, and a secondary coil of the assembly 4 of the motor vehicle 3, which is not shown. In the exemplary embodiments shown in FIGS. 3 and 4, the coil 5 has at least one coil winding 9 and is designed as a flat coil 20. The motor vehicle 3 is located on an underground 6 for inductive charging by means of the charging device 2 and, in particular, is parked on the underground 6. In the exemplary embodiment shown in FIG. 1, the floor assembly 1 is arranged on the underground 6 and lies on the underground 6. In the exemplary embodiment shown in FIG. 2, the floor assembly 1 is arranged in a recess and embedded in the underground 6, so that the floor assembly 1 is more or less flush with the underground 6.

The floor assembly 1 has a plate 8 with which the floor assembly 1 rests on the underground 6 or in the recess. Plate 8 is also referred to below as base plate 8. The base plate 8 is spaced from the coil 5 in a direction 7, which is also referred to below as the spacing direction 7. The spacing direction 7 runs along the soldering direction and corresponds in particular to a surface normal of the base plate 8.

As can be seen in FIGS. 3 and 4, the floor assembly 1 also has a core arrangement 10 comprising at least one core body 11 for magnetic flux guidance. The core arrangement 10 is spaced from the base plate 8 in the spacing direction 7. In addition, the core arrangement 10 is arranged between the base plate 8 and the coil 5 in the spacing direction 7. A cavity 14 is thus formed between the core arrangement 10 and the base plate 8. In the exemplary embodiments shown, the core arrangement 10 has at least two core bodies 11, which are spaced apart from one another. In the exemplary embodiments shown, the core bodies 11 are formed as ferrite bodies 21 which extend transversely to the spacing direction 7 in the shape of a plate. At least one body 15 extends between at least one of the at least one core body 11 and the base plate 8, which extends through the cavity 14 in the spacing direction 7 and supports the core arrangement 10 on the base plate 8. The body 15 is also referred to below as the support column 15. In the exemplary embodiments shown, an associated support column 15 is provided for the respective core body 11, which extends in the spacing direction 7 from the base plate 8 in the direction of the associated core body 11 and thus in particular supports the associated core body 11 on the base plate 8. Preferably, the respective support column 15 rests locally and centrally on the associated core body 11. An electronic system 16 of the floor assembly 1, for example for supplying the coil 5, is arranged in the cavity 14. As can be seen from FIGS. 3 to 8, at least one of the at least one support column 15 has a contour 19. As shown in FIGS. 3 and 4, the electronic system 16 is mechanically pressurized against the base plate 8 in the spacing direction 7 by means of at least one of the at least one contours 19. This results in improved heat transfer between the electronic system 16 and the base plate 8. As a result, the temperature control of the electronic system 16 via the base plate 8 is improved. In particular, this results in improved cooling of the electronic system 16 via the base plate 8. Consequently, this results in simplified temperature control of the electronic system 16. Accordingly, the electronic system 16 and consequently the floor assembly 1 can be operated with increased power and/or a so-called “derating”, in which the power of the floor assembly 1 is specifically regulated down due to increased temperatures, in particular to avoid damage, can at least be reduced. As a result, the floor assembly 1 can be operated with increased power and/or damage to the floor assembly 1 due to heat generated during operation can at least be reduced.

As can be seen from FIGS. 3 to 8, the “contour 19” refers to a cross-section of the associated support column 15 that changes along the spacing direction 7. This change in cross-section is such that the mechanical pressure can be exerted on the electronic system 16 in the direction of the base plate 8, advantageously by means of an interlocking connection.

As can be seen from FIG. 3, the mechanical pressure on the electronic system 16 by means of the contour 19 can take place directly by means of the contour 19. Alternatively or additionally, as can be seen from FIG. 4, the mechanical pressure on the electronic system 16 by means of the contour 19 can be effected indirectly by means of a body 23 which interacts mechanically with the contour 19 and the electronic system 16 and is hereinafter also referred to as hold-down device 23. In the exemplary embodiment shown, the hold-down device 23 is arranged between the contour 19 and the electronic system 16 and is in direct contact with them.

The respective support column 15 is in contact with the base plate 8, at least during operation of the floor assembly 1. In the exemplary embodiments shown and preferably, the respective support column 15 is mechanically fixed to the base plate 8 on its side facing the base plate 8. This results in a defined support of the core arrangement 10 on the base plate 8. In addition, it is thus possible to specify a defined distance between the support column 15 and thus the contour 19 and the base plate 8 in the spacing direction 7 and/or to limit changes to this distance. As a result, the electronic system 16 is subjected to the same or constant mechanical pressure against the base plate 8 by means of the at least one contour 19. This leads to improved heat transfer between the electronic system 16 and the base plate 8. As can be seen from FIGS. 3 and 4, the respective support column 15 can be fixed to the base plate 8 in a material-locking manner by means of an adhesive bond 27 and/or, as can be seen from FIG. 3, by means of a screw connection 28. If a screw connection 28 is provided, a seal 31 is preferably provided in the region of the screw connection 28, as can also be seen from FIG. 3, in order to seal the openings required for the screw connection 28 such that the cavity 14 is sealed off from the outside.

The mechanical pressure on the electronic system 16 in the direction of the base plate 8 by means of the at least one contour 19 holds the electronic system 16 in the cavity 14 in the spacing direction 7. As can be seen from FIG. 4, other measures can be taken to hold the electronic system 16 transverse to the spacing direction 7. In the exemplary embodiment shown in FIG. 4, at least one connection dome 29 protrudes from the base plate 8 for this purpose. The connection dome 29 advantageously allows movement of the electronic system 16 in the spacing direction 7.

In the exemplary embodiments shown, the electronic system 16 has, purely by way of example, a printed circuit board 17 and electronic components 18, which are only shown in FIG. 4 and are attached to the printed circuit board 17. The electronic components 18 are in particular those of a power electronic system. As can be seen from FIG. 4, the electronic components 18 are preferably arranged on the side of the electronic system 16 facing the base plate 8, in particular the printed circuit board 17. Since the components 18 usually generate increased heat during operation, this results in effective and improved cooling of the components 18 via the base plate 8.

In the embodiments shown, as can be seen in FIGS. 3 and 4, a thermal interface material 22, also known by the abbreviation “TIM”, is arranged between the electronic system 16 and the base plate 8. The thermal interface material 22 preferably lies flat on the electronic system 16 and on the base plate 8 and increases the heat transfer between the electronic system 16 and the base plate 8. This leads in particular to improved cooling of the electronic system 16 and consequently to an increased possible performance of the floor assembly 1 and/or to reduced derating and/or to an increased service life. In the embodiments shown, the thermal interface material 22 is pressed against the base plate 8 by the pressure acting on the electronic system 16 by means of the contour 19. This leads to improved contact of the thermal interface material 22 both with the electronic system 16 and with the base plate 8. Overall, therefore, there is improved heat transfer between the electronic system 16 and the base plate 8. In the exemplary embodiments shown, the thermal interface material 22 is elastic in the spacing direction 7, wherein the impact compresses the thermal interface material 22 in the spacing direction 7. This leads to a reduced thermal resistance between the base plate 8 and the electronic system 16 and consequently to a further improved heat transfer between the electronic system 16 and the base plate 8. The elastic properties of the thermal interface material 22 and the mechanical pressure also mean that changes in spacing in the spacing direction 7, for example over the service life of the floor assembly 1, are compensated for. This leads to an improved thermal connection between the electronic system 16 and the base plate 8, even if such changes in distance occur. In addition, the elastic property of the thermal interface material 22 compensates for changes in the mechanical pressure on the electronic system 16. This means that the electronic system 16 is thus subjected to a defined force or a defined pressure against the base plate 8, wherein this defined force is maintained even in the event of said changes in distance. This leads to further improved heat transfer between the electronic system 16 and the base plate 8, even if said changes in distance occur. Furthermore, damage to the electronic system 16 can be avoided or at least reduced in this way. As can be seen from FIG. 3, the thermal interface material 22 can be arranged over the entire surface between the electronic system 16 and the base plate 8, wherein the thermal interface material 22 is recessed in the regions of the support column 15, so that the support columns 15 are supported on the base plate 8 through the electronic system 16 and the thermal interface material 22. As can be seen from FIG. 4, the thermal interface material 22 can alternatively only be arranged in regions with increased heat generation between the base plate 8 and the electronic system 16. These regions with increased heat generation are, as explained above, the electronic systems 18, so that in the exemplary embodiment shown in FIG. 4, the thermal interface material 22 is only arranged locally between the components 18 and the base plate 8.

In the exemplary embodiment shown in FIG. 3, in which the contour 19 of the visible support column 15 mechanically acts on the electronic system 16 directly in the spacing direction 7 against the base plate 8, the contour 19 is designed in a purely exemplary stepped manner, wherein the contour 19 rests directly on the side of the electronic system 16 facing away from the base plate 8. As a result, the support column 15 acts mechanically on the electronic system 16 via the contour 19 in the direction of the base plate 8.

In the exemplary embodiment shown in FIG. 4, in which the contours 19 of the visible support columns 15 act on the electronic system 16 indirectly in the direction of the base plate 8 via the hold-down device 23 arranged in the cavity 14, the respective support column 15 has, purely by way of example, at least one projection 30 projecting transversely to the spacing direction 7 to form the associated contour 19. The hold-down device 23 is clamped between the projections 30 and the electronic system 16, in particular the printed circuit board 17, so that the hold-down device 23 acts mechanically on the electronic system 16 in the direction of the base plate 8. The hold-down device 23 is in contact with the respective at least one associated contour 19 of at least one support column 15 and with the electronic system 16. In the exemplary embodiment shown, the hold-down device 23 is in direct contact with the associated contours 19 to be assigned to two support columns 15 and with the printed circuit board 17.

The hold-down device 23 is made of a magnetically and/or electromagnetically inactive, preferably dielectric and/or electrically insulating, material in order not to influence the magnetic and/or electromagnetic fields present in the cavity 14 during operation as far as possible. The hold-down device 23 is in particular a plastic body 24. In the exemplary embodiment shown in FIG. 4, the hold-down device 23 is also designed as a spring element 25, which acts resiliently in the spacing direction 7. For this purpose, the hold-down device 23 in the exemplary embodiment shown is made of a thin-walled material and shaped accordingly.

The base plate 8 is advantageously made of a metal or a metal alloy. This leads to improved heat transfer between the base plate 8 and the electronic system 16. In addition, the base plate 18 can in this way also serve as magnetic and/or electromagnetic shielding of the floor assembly 1. In the embodiments shown, the base plate 8 is also provided with channels 32 through which a fluid can flow during operation. Heat is thus transferred between the base plate 8 and the fluid, resulting in improved temperature control of the electronic system 16. In particular, the fluid absorbs heat from the base plate 8 during operation, so that the base plate 8 improves the cooling of the electronic system 16.

As can be seen in FIGS. 3 and 4, for example, the base plate 8 extends transversely to the spacing direction 7 beyond the electronic system 16. Thus, the base plate 8 also tempers the cavity 14, so that the cavity 14 and consequently the core arrangement 10 and/or the coil 5 are also tempered, in particular cooled, by means of the base plate 8.

The respective contour 19 can be formed on the associated support column 15 and thus be monolithic with the associated support column 15. The contour 19 can also be produced separately and then attached to the associated support column 15. It is also conceivable to attach at least one of the contours 19 to the associated support column 15 so that it can be adjusted in the spacing direction 7. This makes it possible, for example, to change the mechanical pressure on the electronic system 16 in the direction of the base plate 8 as required. Furthermore, the floor assembly 1 can be mounted more easily in this way. The arrangement of the contour 19 on the associated support column 15, which can be adjusted in the spacing direction, can be carried out, for example, via a thread 26, which is only indicated in FIG. 4.

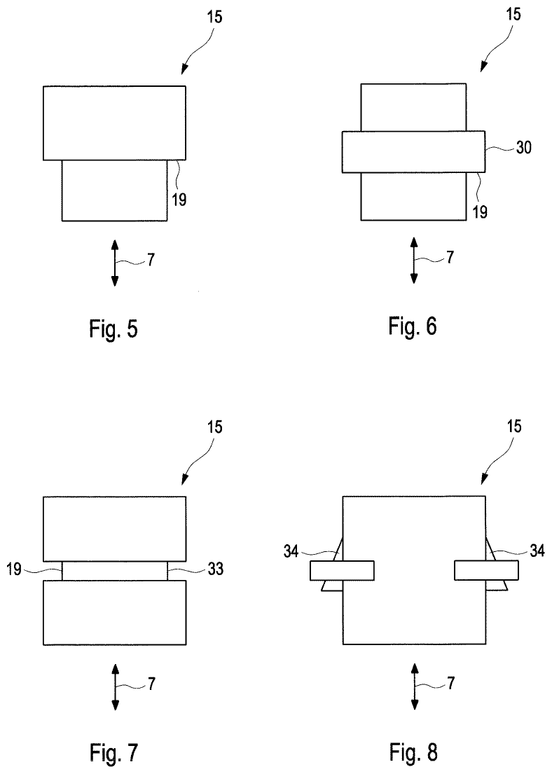

FIGS. 5 to 8 show further exemplary embodiments of the contours 19 in a side view of the support columns 15. In the exemplary embodiment of FIG. 5, the support column 15 is stepped, wherein the cross-section of the support column 15 increases in steps in the spacing direction 7 towards the core arrangement 10 in order to form the contour 19. The exemplary embodiment in FIG. 6 differs from the exemplary embodiment shown in FIG. 4 in that the projection 30 is arranged in the center of the support column 15 in the spacing direction 7. In the exemplary embodiment shown in FIG. 7, the support column 15 has a recess 33 extending transversely to the spacing direction 7 to form the contour 19. In the exemplary embodiment shown in FIG. 8, the support column 15 has at least one protruding extension 34 on the outside transverse to the spacing direction 7. The respective contour 19 can be symmetrical and circumferentially closed and/or only provided locally on the associated support column 15.

As FIGS. 3 and 4 show, in the embodiments shown, the floor assembly 1 has a holder 12 for holding the core arrangement 10. The core arrangement 10 is held in the floor assembly 1 by means of the holder 12 and supported on the base plate 8. The holder 12 has the support columns 15 to support the core arrangement 10. In addition, the holder 12 has a retaining structure 13 spaced from the base plate 8 in the spacing direction 7, wherein the at least one core body 11 is arranged on the side of the retaining structure 13 facing away from the base plate 8 and is positioned by the retaining structure 13 in a plane extending transversely to the spacing direction 7.

As can also be seen from FIGS. 3 and 4, the floor assembly 1 has an upper structure 35 on the side facing away from the core arrangement 10 in the spacing direction 7, which holds the coil 5 and is mechanically connected to the holder 12 such that a load acting on the floor assembly 1, for example by a motor vehicle 3, is transmitted from the structure 35 into the support columns 15 and then into the base plate 8. The structure 35 and the holder 12 are designed such that this takes place without damage. In particular, the structure 35, the holder 12 and the base plate 8 are designed with regard to their mechanical stability and load-bearing capacity.

1. A floor assembly for an inductive charging device for inductive charging a motor vehicle on an underground, comprising:
a base plate and a coil, which are spaced apart from each other in a spacing direction,
a core arrangement having at least one core body for magnetic flux guidance, the core arrangement is spaced apart from the base plate and the coil in the spacing direction and is arranged between the base plate and the at least one coil,
wherein a cavity is formed between the core arrangement and the base plate,
at least one support column extends between at least one of the at least one core body and the base plate, the at least one support column extends through the cavity in the spacing direction and supports the core arrangement on the base plate,
an electronic system arranged in the cavity,
wherein at least one of the at least one support column has a contour, and
wherein the electronic system is mechanically pressurized against the base plate in the spacing direction via the contour.

2. The floor assembly according to claim 1, further comprising a thermal interface material arranged between the electronic system and the base plate, the thermal interface material pressed against the base plate by the pressure acting on the electronic system via the contour.

3. The floor assembly according to claim 2, wherein:
the thermal interface material is elastic in the spacing direction, and
the impact compresses the thermal interface material in the spacing direction.

4. The floor assembly according claim 1, wherein the contour mechanically acts on the electronic system directly in the spacing direction against the base plate.

5. The floor assembly according to claim 4, wherein the contour rests on the side of the electronic system facing away from the base plate.

6. The floor assembly according to claim 1, wherein:
at least one hold-down device is arranged in the cavity,
the contour mechanically acts on the at least one hold-down device in the direction of the base plate, so that the at least one hold-down device mechanically acts on the electronic system in the spacing direction against the base plate.

7. The floor assembly according to claim 6, wherein the at least one hold-down device abuts at least one of the contour and the electronic system.

8. The floor assembly according to claim 6, wherein the at least one hold-down device is electrically insulating.

9. The floor assembly according to claim 6, wherein the at least one hold-down device is a spring element acting in the spacing direction.

10. The floor assembly according to claim 1, wherein the contour on the at least one support column is adjustable in the spacing direction.

11. The floor assembly according to claim 10, wherein the at least one support column is attached to the at least one support column via a thread and is thus adjustable in the spacing direction.

12. The floor assembly according to claim 1, wherein the electronic system has a printed circuit board, wherein the electronic system is mechanically pressurized against the base plate via the printed circuit board.

13. The floor assembly according to claim 1, wherein the electronic system has at least one electronic component that is arranged on the side of the electronic system facing the base plate.

14. The floor assembly according to claim 1, wherein the at least one support column is connected to the base plate in a material-locking manner.

15. The floor assembly according to claim 1, wherein the at least one support columns is connected to the base plate via a screw connection.

16. An inductive charging device, comprising: a floor assembly, the floor assembly including:
a base plate and a coil spaced apart from each other in a spacing direction,
a core arrangement having at least one core body for magnetic flux guidance, the core arrangement is spaced apart from the base plate and the coil in the spacing direction and is arranged between the base plate and the at least one coil,
wherein a cavity is formed between the core arrangement and the base plate,
at least one support column extends between at least one of the at least one core body and the base plate, the at least one support column extends through the cavity in the spacing direction and supports the core arrangement on the base plate,
an electronic system arranged in the cavity,
wherein the at least one support column has a contour, and
wherein the electronic system is mechanically pressurized against the base plate in the spacing direction via the contour.

17. The inductive charging device according to claim 16, wherein the floor assembly further includes a thermal interface material arranged between the electronic system and the base plate, the thermal interface material pressed against the base plate by the pressure acting on the electronic system via the contour.

18. The inductive charging device according to claim 17, wherein:
the thermal interface material is elastic in the spacing direction, and
the impact compresses the thermal interface material in the spacing direction.

19. The inductive charging device according to claim 16, wherein the contour mechanically acts on the electronic system directly in the spacing direction against the base plate.

20. The inductive charging device according to claim 19, wherein the contour rests on the side of the electronic system facing away from the base plate.
